(19) United States
(12) Patent Application Publication
(10) Pub. No.: US 2020/0057660 A1
(43) Pub. Date: Feb. 20, 2020

(54) METHOD AND SYSTEM FOR RENDERING USER INTERFACES

(71) Applicant: Alibaba Group Holding Limited, George Town (KY)

(72) Inventors: Zheng Liu, Shanghai (CN); Xu Zeng, Shanghai (CN); Yongcai Ma, Shanghai (CN); Lidi Jiang, Shanghai (CN); Kerong Shen, Shanghai (CN); Decai Jin, Hangzhou (CN); Chong Zhang, Beijing (CN); Qinghe Xu, Shanghai (CN)

(21) Appl. No.: 16/559,047

(22) Filed: Sep. 3, 2019

Related U.S. Application Data
(63) Continuation-in-part of application No. PCT/CN2018/077186, filed on Feb. 26, 2018.

(30) Foreign Application Priority Data
Mar. 8, 2017 (CN) 201710135534.9

(51) Int. Cl. G06F 9/451

(52) U.S. Cl. CPC G06F 9/451

(57) ABSTRACT

Rendering user interfaces is disclosed including acquiring, using a first thread, a to-be-handled user interface render event, the first thread being a thread on a dynamic language application runtime platform, and the dynamic language application runtime platform being preloaded with a render engine, and calling, using the first thread, a corresponding user interface rendering function provided by the render engine based on an interface that corresponds to the event and that is used to call the render engine.

### CROSS REFERENCE TO OTHER APPLICATIONS

This application is a continuation-in-part of and claims priority to International (PCT) Application No. PCT/CN2018/077186, entitled USER INTERFACE RENDERING METHOD AND DEVICE filed on Feb. 26, 2018 which is incorporated herein by reference in its entirety for all purposes, which claims priority to China Patent Application No. 201710135534.9, entitled A METHOD AND MEANS FOR RENDERING USER INTERFACES filed on Mar. 8, 2017 which is incorporated by reference in its entirety for all purposes.

### FIELD OF THE INVENTION

The present application relates to a method and a system for rendering user interfaces.

### BACKGROUND OF THE INVENTION

JavaScript is a dynamic language and has become increasingly popular among developers because of its efficiency, dynamism, ease of use, and other characteristics. Node.js is the JavaScript runtime environment and is also called a runtime platform. Node.js provides many kinds of system-level application programming interfaces (APIs), and is used for building fast-responding and extensible applications.

When JavaScript programs are run, the running of the JavaScript programs relies on a JavaScript interpreter. In front-end development, a browser provides the JavaScript interpreter. Node.js provides a JavaScript runtime environment separately from a browser. The JavaScript interpreter is typically applied in back-end server development.

In existing systems, Node.js does not have graphics rendering capabilities.

### SUMMARY OF THE INVENTION

The present application provides a method and a system for rendering user interfaces.

In some embodiments, a method for rendering user interfaces is provided. The method comprises:

acquiring, using a first thread, a to-be-handled user interface render event, wherein the first thread is a thread on the dynamic language application runtime platform, and wherein the dynamic language application runtime platform is preloaded with a render engine; and

calling, using the first thread, a corresponding user interface rendering function provided by the render engine based on an interface that corresponds to the event and that is used to call the render engine.

In some embodiments, a system for rendering user interfaces is provided. The system comprises:

an acquiring unit configured to acquire, using a first thread, a to-be-handled user interface render event, wherein the first thread is a thread on a dynamic language application runtime platform, and wherein the dynamic language application runtime platform is preloaded with a render engine;

a first handling unit configured to call, using a first thread, the corresponding user interface rendering function provided by the render engine based on an interface that corresponds to the event and that is used to call the render engine.

In some embodiments, one or more computer-readable media are provided. The computer-readable media stores instructions. Upon being executed by one or more processors, the instructions cause a communication device to execute the above method.

In some embodiments, a communication device is provided. The communication device comprises: one or more processors and one or more computer-readable media. The computer-readable media store instructions. In response to a determination that the instructions are executed by the one or more processors, the communication device is caused to execute the above method.

In some embodiments, a dynamic language application runtime platform is preloaded with a render engine. After a first thread on the platform acquires a to-be-handled user interface render event, the first thread can, based on an interface that corresponds to the event and that is used to call the render engine, call the corresponding user interface rendering function provided by the render engine. Thus, implementing user interface rendering functions on the platform based on the render engine is possible and thereby integrates user interface rendering capabilities with the platform.

### BRIEF DESCRIPTION OF THE DRAWINGS

Various embodiments of the invention are disclosed in the following detailed description and the accompanying drawings.

FIG. 1 shows a diagram of an embodiment of an operating system architecture.

FIG. 2 presents a diagram of an embodiment of Node.js preloaded with a render engine.

FIG. 3 presents a diagram of an embodiment of render engine interface mapping relationships.

FIG. 4 presents a diagram of an embodiment of a Node.js resource preloaded with a render engine.

FIG. 5 presents a structural diagram of an embodiment of a render engine.

FIG. 6 presents a diagram of an embodiment of a procedure for preloading Node.js.

FIG. 7 presents a diagram of an embodiment of a process for rendering a user interface.

FIG. 8 presents a diagram of an embodiment of an event looping mechanism.

FIG. 9 presents a diagram of an embodiment of a system for rendering a user interface.

FIG. 10 is a functional diagram illustrating a programmed computer system for rendering a user interface in accordance with some embodiments.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

An operating system can be used to provide user applications (apps) with basic capabilities of the operating system. The operating system can be implemented based on a dynamic language application runtime platform and thus provides a runtime environment for dynamic language applications. Node.js is a JavaScript runtime environment or runtime platform. The dynamic language application runtime platform is preloaded with a plurality of modules called common modules, and the common modules provide specific functions, such as system service functions (such as clock, audio/video, etc.).

Dynamic language is a kind of computer programming language that can dynamically change type or structure of functions and attributes while the dynamic language is running. For example, functions and attributes can be added, modified, and/or deleted while a dynamic language is running. For example, JavaScript, Python, and Ruby are all dynamic languages. The dynamic language can run without having been compiled. The dynamic requires support when running. The environment that provides the dynamic language with runtime support is called a runtime environment. The runtime environment includes elements, such as a Java virtual machine and a JavaScript engine, required to run a dynamic language.

Using a host system in a cloud operating system (e.g., AliOS) as an example, the host system is implemented on Node.js. Node.js is a JavaScript runtime environment, and a web application framework built on Chrome's JavaScript engine. In other words, the operating system, based on Node.js, provides user apps with the basic capabilities of an operating system. Node.js includes multiple modules, which are called common modules. These modules can be obtained by packaging code used to implement specific functions (e.g., code that implements operating system-level service functions). For example, the modules are packaged in the form of components. As an example, these modules include components for implementing positioning functions of the Global Positioning System (GPS), components for implementing power source management functions, etc. Interfaces for these modules are exposed to the application layer. Applications in the application layer can execute functions provided by these modules by calling these modules' interfaces and analyzing code in the modules with the JavaScript engine. In this way, the interfaces implement functions provided by these modules.

Currently, back-end server applications typically run on Node.js. The user interfaces of the back-end server applications use a render engine for rendering. The render engine typically uses rendering graphic interfaces and does not integrate with other common modules used for programming. Using such a render engine to develop user interfaces requires writing or integrating a large number of common modules. This technique for developing user interfaces is therefore cumbersome and inefficient. Although Node.js provides a wide array of JavaScript APIs, and developers can use the modules provided by Node.js for quick development of functions, Node.js lacks a user interface rendering capability.

To address the lack of a user interface rendering capability, the present application provides embodiments for merging a render engine and Node.js.

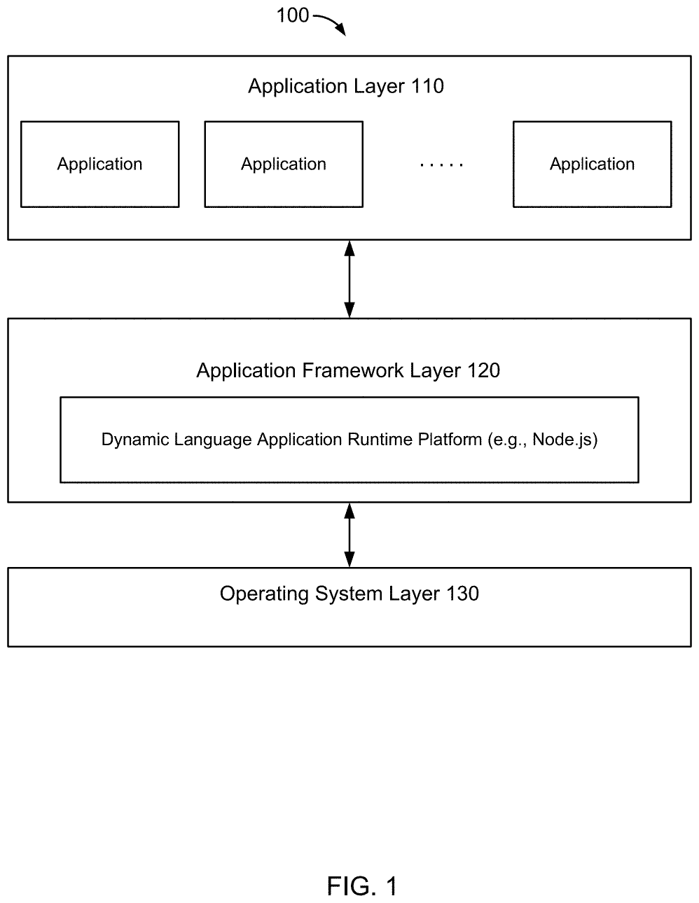

FIG. 1 shows a diagram of an embodiment of an operating system architecture. In some embodiments, the operating system architecture 100 comprises an application layer 110, an application framework layer 120, and an operating system layer 130. In some embodiments, the application layer 110 comprises one or more applications (apps). In some embodiments, the application framework layer 120 includes a dynamic language application runtime platform (e.g., Node.js). In some embodiments, the operating system layer 130 provides operating system-level repositories and basic system services. For example, the provided system services include device driver services, event management services, etc.

In some embodiments, the render engine enables access to capabilities provided by a dynamic language application runtime platform such as Node.js based on the above operating system architecture 100.

Once the dynamic language application runtime platform is activated, the dynamic language application runtime platform can preload various common modules, and the dynamic language application runtime platform can further preload a render engine as a standard module of the dynamic language application runtime platform.

Using Node.js as an example of a dynamic language application runtime platform, the Node.js process is created in response to a determination that Node.js is activated. The Node.js process preloads various capabilities. “Capabilities,” as used here, can also be referred to as resources, which can include modules (e.g., components) for implementing specific functions, as described above. Capabilities can also include configuration information and/or resources such as context and event queues. The capabilities preloaded by Node.js include at least a render engine. The preloaded capabilities can also include capabilities provided by Node.js. The capabilities provided by Node.js can include: common modules within Node.js (e.g., components used to provide specific functions or services) and/or information relating to the JavaScript runtime environment. Common modules in Node.js can be obtained by packaging JavaScript code used to implement specific functions. Each module has an interface (e.g., API), which can be provided to the application layer and made available for calling by a program. Information relating to the JavaScript runtime environment can include one or more of JavaScript engine context and/or event loop-related configurations. The context is used to describe various objects, statuses, and/or functions internal to the engine. JavaScript engine context can include interfaces (e.g., APIs) of modules preloaded by the Node.js process. Event loop-related configurations can specifically include Node.js event queue configurations, e.g., memory location of an event queue and/or queue size.

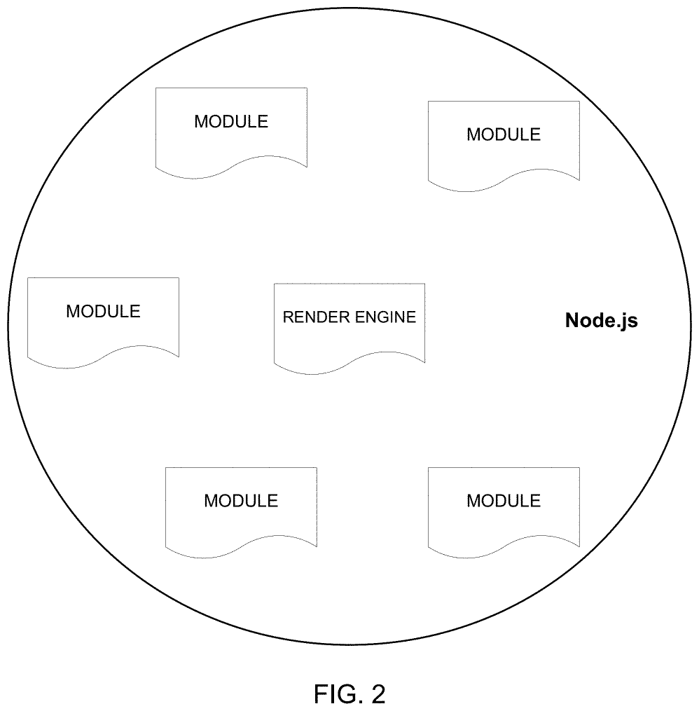

The Node.js process can package a preloaded capability (e.g., a render engine) as a standard module for Node.js, and the preloaded capability can be preloaded in Node.js as a standard module. FIG. 2 presents a diagram of an embodiment of Node.js preloaded with a render engine.

In some embodiments, the render engine is implemented by a dynamic language (such as JavaScript). In other words, the functions included in the render engine are written in a dynamic language (such as JavaScript). In some embodiments, the implementation of the render engine can be split into two parts. For performance considerations and using multiple threads, one part can be implemented using a compiled programming language such as C/C++, and the other part can be implemented using a dynamic language such as JavaScript. In some embodiments, the render engine is entirely implemented in a programming language such as C/C++.

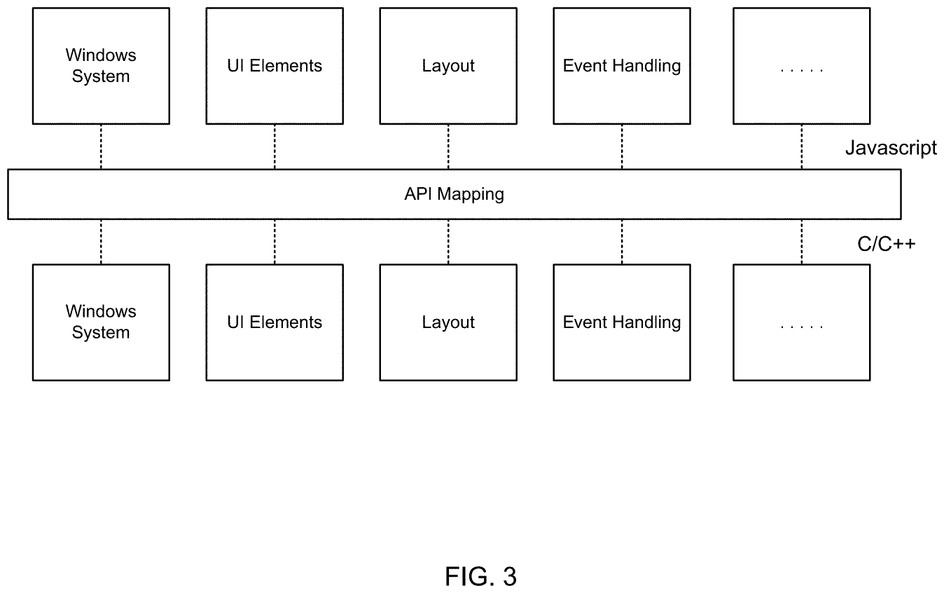

In the case of a render engine that is fully or partially implemented in a compiled programming language such as C/C++, the render engine can provide a compiled programming language API. The compiled programming language API can be used to call user interface rendering functions that are based on the compiled programming language and provided by the render engine. In other words, the compiled programming language API can call functions included in the render engine that are written in the compiled programming language. Regarding the dynamic language application runtime platform, the dynamic language application runtime platform can support a dynamic language. For example, Node.js supports JavaScript. Therefore, the compiled programming language API (e.g., a C/C++ API) provided by the render engine is to map to a dynamic language API (e.g., a JavaScript API) supported by the dynamic language application runtime platform (e.g., Node.js) and to provide the mapped APIs to the application layer. The dynamic language application runtime platform (e.g., Node.js) stores the API mapping relationships. FIG. 3 presents a diagram of an embodiment of render engine interface mapping relationships. The render engine can include multiple components, e.g., window system components, user interface (UI) element components, layout components, event handling components, etc. The APIs of the C/C++ standard-compliant components can be mapped on a one-to-one basis to corresponding JavaScript standard-compliant APIs.

In the case of a render engine that is fully implemented in a dynamic language (such as JavaScript), the render engine can provide dynamic language APIs. The dynamic language APIs can be used to call user interface rendering functions that are based on a compiled programming language and provided by the render engine. In other words, the dynamic language APIs can call functions included in the render engine that are written in a compiled programming language. Since a dynamic language runtime platform (e.g., Node.js) supports a dynamic language, such as JavaScript, API mapping is not needed.

In some embodiments, capabilities preloaded on the dynamic language runtime platform can also include one or more of the following:

—Operating System-Provided Capabilities

Operating system-provided capabilities can include: system services provided by an operating system layer, etc. The operating system layer can include modules that provide system services. These modules can be obtained by packaging code used to implement specific functions. Each module has an interface (e.g., API). In some embodiments, the operating system capabilities are preloaded by adding APIs of modules in the operating system layer to the context of a dynamic language engine (e.g., a JavaScript engine).

—User-Defined Capabilities

User-defined capabilities, i.e., user-defined code for implementing specific functions, can be packaged into modules, with each module having an interface (e.g., API). In some embodiments, the user-defined capabilities are preloaded by adding APIs of user-defined modules to the context of a dynamic language engine (e.g., a JavaScript engine).

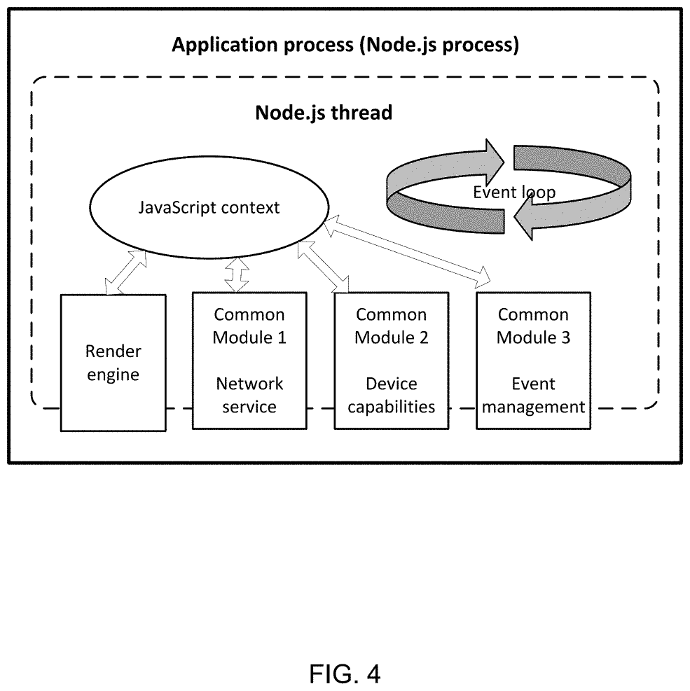

Using Node.js as an example of a dynamic language application runtime platform, FIG. 4 presents a diagram of an embodiment of a Node.js resource preloaded with a render engine. As shown in FIG. 4, an application process includes a Node.js thread. The Node.js thread can handle user interface rendering and other events using a Node.js event loop mechanism. The Node.js thread is configured to render user interfaces based on the render engine. As an example, the Node.js thread is configured to: render an application user interface by calling an interface provided by the render engine; implement a network service function by calling an interface provided by Common Module 1; implement a device capability query function by calling an interface provided by Common Module 2; and implement an event management function by calling an interface provided by Common Module 3.

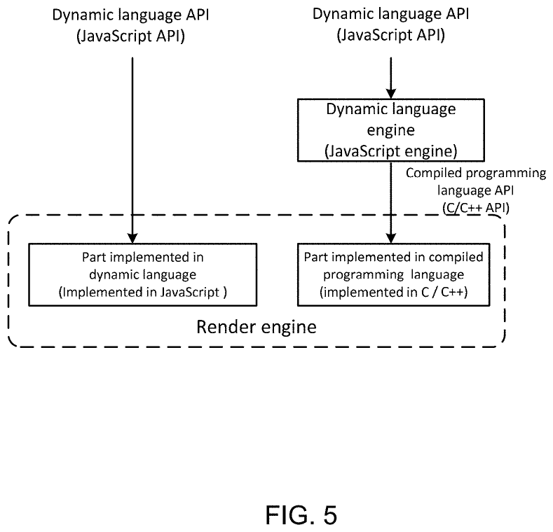

FIG. 5 presents a structural diagram of an embodiment of a render engine. As shown, the render engine is split into two parts. For performance considerations and for taking advantage of the capabilities of multiple threads, one part of the render engine can be implemented using a compiled programming language (such as C/C++), and the other part of the render engine can be implemented using a dynamic language (such as JavaScript). Using the examples of C/C++ as the compiled programming language and JavaScript as the dynamic language, in the event that the Node.js thread is to call the part of the render engine that is implemented in JavaScript, the Node.js thread calls the corresponding function in this part of the render engine based on the JavaScript API, and if the Node.js thread is to call the part of the render engine that is implemented in C/C++, the Node.js thread sends a call instruction to the JavaScript virtual machine. The call instruction includes a JavaScript API. The JavaScript virtual machine maps the JavaScript API to a corresponding C/C++ API and calls, based on the mapped C/C++ API, the corresponding function in the part of the render engine implemented by C/C++ to implement the user interface rendering function.

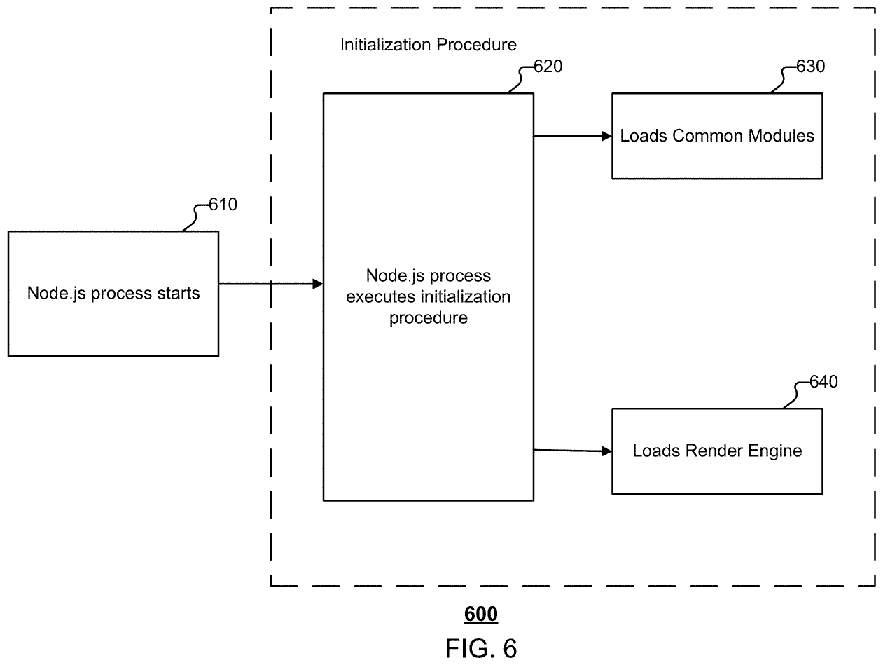

Using the example of Node.js, FIG. 6 presents a diagram of an embodiment of a procedure for preloading Node.js. The procedure 600 describes, as an example, the Node.js start procedure. As shown in 610, the Node.js process is started. For example, when a JavaScript application is started, the corresponding Node.js process is started. In operations 620 through 640, the Node.js process performs an initialization procedure. During the procedure 600, the Node.js process preloads the render engine and common modules. The common modules can include network modules, system modules, etc. The preloading procedure is discussed above and not repeated for conciseness.

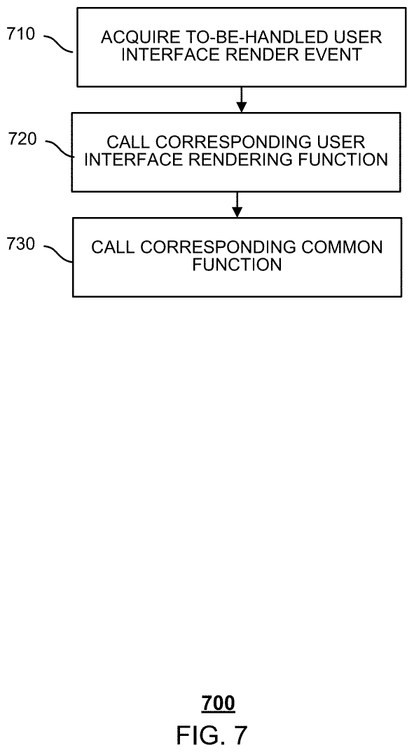

FIG. 7 presents a diagram of an embodiment of a process for rendering a user interface. As shown in FIG. 7, in some embodiments, the process 700 is implemented by a client implementing the operating system architecture 100 of FIG. 1 and comprises:

In 710, the client acquires, using a first thread, a to-be-handled user interface render event. The to-be-handled user interface render event is acquired from an event queue.

In 720, the client, using the first thread, calls the corresponding user interface rendering function provided by a render engine based on an interface that corresponds to the event and that is used to call the render engine. The first thread can be a Node.js thread. As an example, the user interface render event is generated in the following situation: a situation where a user interface is to be refreshed as a result of a user operation. For example, a user touches the screen to switch the display from a first application to a second application. Therefore, in this example, the interface that corresponds to the event is the display interface of the second application, the content displayed on the screen is to be refreshed to display the user interface of the second application, and the user interface event corresponds to the refreshing of the second application. In another example, when the user taps a function key on the user interface to open a page, a user interface render event indicating that the page is to be opened will be generated.

Furthermore, if an app corresponding to the first thread also calls, based on a common module interface, a function provided by the common module, then, in 730, the client is to call, based on the first thread, the corresponding common function provided by the common module (e.g., networking function provided by a networking module, a system service function provided by a system module, etc.) using the common module interface that corresponds to the event and that is used to call the common module interface.

In some embodiments, the interface provided by the render engine includes a compiled programming language interface. The nature language interface is mapped to a dynamic language interface. The compiled programming language interface is used to call the user interface rendering function provided in compiled programming language in the render engine. The dynamic language is a Node.js-supported dynamic language. Thus, in operation 720, the Node.js thread can acquire the dynamic language interface that corresponds to the event and that is used to call the render engine, map the acquired dynamic language interface to the corresponding compiled programming language interface, and call the corresponding user interface rendering function provided by the render engine based on the mapped compiled programming language interface.

Node.js employs an event loop mechanism. In some embodiments, the render engine is preloaded onto Node.js. Therefore, render engine events and Node.js events can undergo event looping based on a Node.js event queue. Event looping refers the continuous reading and processing of events from the event queue. If no event occurs, the event loop is in a waiting mode and is blocked. In the event that a Node.js event or a render engine event occurs, the event loop is woken up. For example, in the event that a render engine event occurs, the event loop can be woken up asynchronously, and the render engine event is stored to the event queue. The event queue typically uses a first-in first-out mechanism.

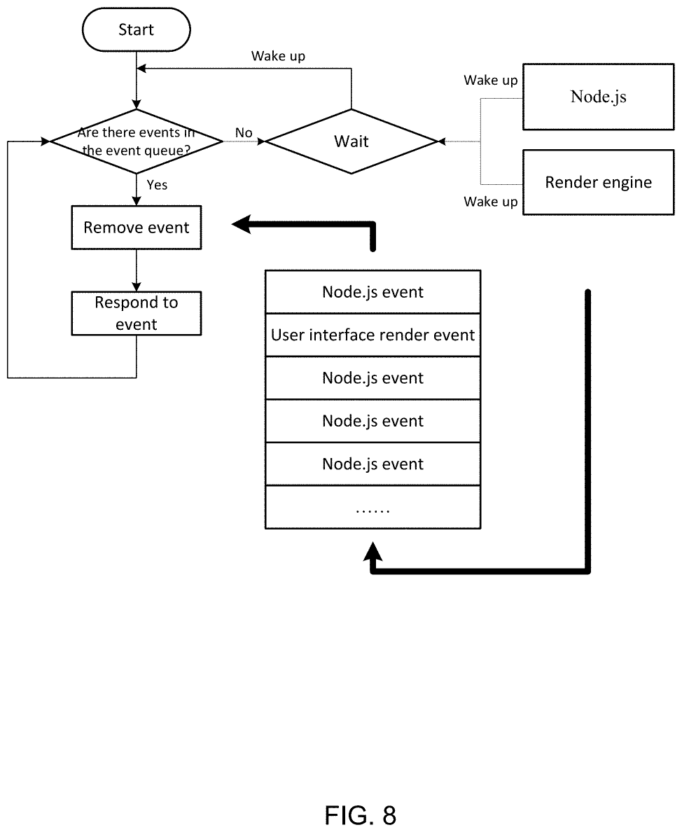

FIG. 8 presents a diagram of an embodiment of an event looping mechanism. As shown in FIG. 8, Node.js events and render engine events are stored in the queue in the order the events occur. In the event that, while the Node.js thread is reading events from the event queue and responding, the currently read item is a user interface render event, then the Node.js thread calls a corresponding function in the render thread to implement a user interface rendering function based on the interface that corresponds to the user interface render event and that is used to call the render engine. As an example, when a user touches the screen to switch from one application to another application, a user interface render event is to be triggered. In the event that the Node.js thread is currently reading another Node.js event, then the Node.js thread calls a corresponding function module based on the interface that corresponds to the read Node.js event and that is used to call a common module. Thus, handling of events in the render engine is merged into the Node.js event loop.

In some embodiments, an asynchronous handling mechanism is employed to handle events. As an example, a callback function is registered with the Node.js thread. This callback function is used to notify the Node.js thread if a user interface render event occurs. In this way, if a user interface render event enters the queue, the Node.js process can be notified through the callback function. Upon receiving a notification of the callback function, the Node.js process can acquire a to-be-handled user interface render event from the Node.js event queue.

In some embodiments, another thread manages the Node.js event queue. For convenience, a thread that is used to manage a Node.js event queue is called an event thread in this embodiment. The event thread can be linked to the operating system so that the event thread receives operating system-related events from the operating system and stores these operating system-related events in the Node.js event queue. The operating system-related events can include: key events, touch events, and render events.

In some embodiments, Node.js includes common modules and a render engine.

After the Node.js thread acquires a to-be-handled user interface render event, the Node.js thread can acquire an interface that corresponds to the event and that is used to call the render engine, and call, based on the acquired interface that is used to call the render engine, the corresponding user interface rendering function provided by the render engine. On the other hand, the Node.js thread can acquire an interface that corresponds to the event and that is used to call a common module, and call, based on the acquired interface that is used to call the common module, the corresponding common function provided by the common module. Since Node.js includes a render engine, the Node.js thread can render a user interface in Node.js using the render engine. Further, since Node.js also includes common modules, the first thread can also implement common functions in Node.js using the common modules. User interface rendering capabilities are thus integrated into Node.js for the program development convenience of developers. In other words, a developer only needs to develop an application that can run on Node.js, and this application will be capable of using common functions provided by common modules in Node.js and also be capable of using user interface rendering functions provided by the render engine in Node.js.

The above embodiments can be applied to mobile terminals, such as mobile phones, smart wearable devices, vehicle-mounted devices, and personal digital assistants (PDAs). In an example relating to a cloud operating system-based mobile phone, the Node.js thread can render a user interface based on a render engine and thus enable user interface rendering operations to use capabilities provided by Node.js, thus achieving a merger of Node.js with the render engine.

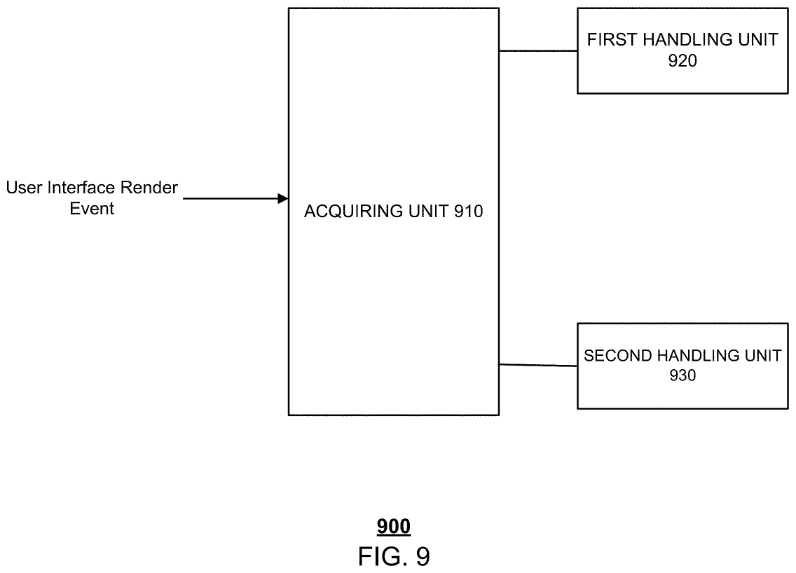

FIG. 9 presents a diagram of an embodiment of a system for rendering a user interface. In some embodiments, the system 900 can implement the process 700 of FIG. 7 and comprises: an acquiring unit 910 and a first handling unit 920. In some embodiments, the system 900 further comprises a second handling unit 930.

In some embodiments, the acquiring unit 910 is configured to acquire a to-be-handled user interface render event. In some embodiments, the first thread is a thread on a dynamic language application runtime platform. In some embodiments, the dynamic language application runtime platform is preloaded with a render engine.

In some embodiments, the first handling unit 920 is configured to acquire an interface that corresponds to the event and that is used to call the render engine, and call, based on the acquired interface used to call the render engine, a corresponding user interface rendering function provided by the render engine.

In some embodiments, the dynamic language application runtime platform is also preloaded with common modules. In some embodiments, the second handling unit 930 is configured to acquire an interface that corresponds to the event and that is used to call the common modules, and call, based on the acquired interface used to call the common modules, corresponding common functions provided by the common modules.

In some embodiments, the interface provided by the render engine includes a first language interface. The first language interface can be mapped to a second language interface. The first language interface is used to call a user interface rendering function provided in the render engine in the first language. The second language corresponds to the dynamic language supported by the dynamic language application runtime platform. In some embodiments, the first handling unit 920 is configured to acquire a second language interface that corresponds to the event and that is used to call the render engine, map the acquired second language interface to the corresponding first language interface, and call, based on the mapped first language interface, the corresponding user interface rendering function provided by the render engine.

In some embodiments, the first handling unit 920 is configured to: send a call instruction to a second language virtual machine. In some embodiments, the call instruction includes a second language interface used to call the render engine, and the call instruction is configured to trigger the second language virtual machine to map the second language interface to the corresponding first language interface, and call, based on the mapped first language interface, the corresponding user interface rendering function provided by the render engine.

In some embodiments, the acquiring unit 910 is configured to acquire a to-be-handled user interface render event from the dynamic language application runtime platform event queue upon receiving a callback function notification. In some embodiments, the callback function is configured to notify the first thread in the event that a user interface render event enters the event queue.

In some embodiments, the dynamic language application runtime platform includes Node.js, and the second language includes JavaScript.

The units described above can be implemented as software components executing on one or more general purpose processors, as hardware such as programmable logic devices and/or Application Specific Integrated Circuits designed to perform certain functions or a combination thereof. In some embodiments, the units can be embodied by a form of software products which can be stored in a nonvolatile storage medium (such as optical disk, flash storage device, mobile hard disk, etc.), including a number of instructions for making a computer device (such as personal computers, servers, network equipment, etc.) implement the methods described in the embodiments of the present invention. The units may be implemented on a single device or distributed across multiple devices. The functions of the units may be merged into one another or further split into multiple sub-units.

The methods or algorithmic steps described in light of the embodiments disclosed herein can be implemented using hardware, processor-executed software units, or combinations of both. Software units can be installed in random-access memory (RAM), memory, read-only memory (ROM), electrically programmable ROM, electrically erasable programmable ROM, registers, hard drives, removable disks, CD-ROM, or any other forms of storage media known in the technical field.

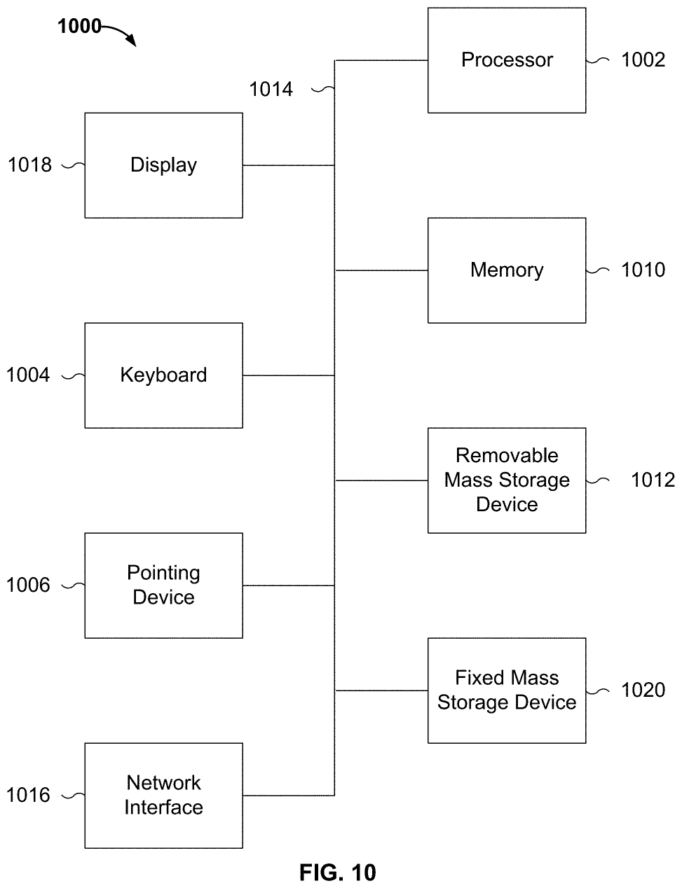

FIG. 10 is a functional diagram illustrating a programmed computer system for rendering a user interface in accordance with some embodiments. As will be apparent, other computer system architectures and configurations can be used to load resources. Computer system 1000, which includes various subsystems as described below, includes at least one microprocessor subsystem (also referred to as a processor or a central processing unit (CPU)) 1002. For example, processor 1002 can be implemented by a single-chip processor or by multiple processors. In some embodiments, processor 1002 is a general purpose digital processor that controls the operation of the computer system 1000. Using instructions retrieved from memory 1010, the processor 1002 controls the reception and manipulation of input data, and the output and display of data on output devices (e.g., display 1018).

Processor 1002 is coupled bi-directionally with memory 1010, which can include a first primary storage, typically a random access memory (RAM), and a second primary storage area, typically a read-only memory (ROM). As is well known in the art, primary storage can be used as a general storage area and as scratch-pad memory, and can also be used to store input data and processed data. Primary storage can also store programming instructions and data, in the form of data objects and text objects, in addition to other data and instructions for processes operating on processor 1002. Also as is well known in the art, primary storage typically includes basic operating instructions, program code, data and objects used by the processor 1002 to perform its functions (e.g., programmed instructions). For example, memory 1010 can include any suitable computer-readable storage media, described below, depending on whether, for example, data access needs to be bi-directional or uni-directional. For example, processor 1002 can also directly and very rapidly retrieve and store frequently needed data in a cache memory (not shown).

A removable mass storage device 1012 provides additional data storage capacity for the computer system 1000, and is coupled either bi-directionally (read/write) or uni-directionally (read only) to processor 1002. For example, storage 1012 can also include computer-readable media such as magnetic tape, flash memory, PC-CARDS, portable mass storage devices, holographic storage devices, and other storage devices. A fixed mass storage 1020 can also, for example, provide additional data storage capacity. The most common example of mass storage 1020 is a hard disk drive. Mass storages 1012 and 1020 generally store additional programming instructions, data, and the like that typically are not in active use by the processor 1002. It will be appreciated that the information retained within mass storages 1012 and 1020 can be incorporated, if needed, in standard fashion as part of memory 1010 (e.g., RAM) as virtual memory.

In addition to providing processor 1002 access to storage subsystems, bus 1014 can also be used to provide access to other subsystems and devices. As shown, these can include a display monitor 1018, a network interface 1016, a keyboard 1004, and a pointing device 1006, as well as an auxiliary input/output device interface, a sound card, speakers, and other subsystems as needed. For example, the pointing device 1006 can be a mouse, stylus, track ball, or tablet, and is useful for interacting with a graphical user interface.

The network interface 1016 allows processor 1002 to be coupled to another computer, computer network, or telecommunications network using a network connection as shown. For example, through the network interface 1016, the processor 1002 can receive information (e.g., data objects or program instructions) from another network or output information to another network in the course of performing method/process steps. Information, often represented as a sequence of instructions to be executed on a processor, can be received from and outputted to another network. An interface card or similar device and appropriate software implemented by (e.g., executed/performed on) processor 1002 can be used to connect the computer system 1000 to an external network and transfer data according to standard protocols. For example, various process embodiments disclosed herein can be executed on processor 1002, or can be performed across a network such as the Internet, intranet networks, or local area networks, in conjunction with a remote processor that shares a portion of the processing. Additional mass storage devices (not shown) can also be connected to processor 1002 through network interface 1016.

An auxiliary I/O device interface (not shown) can be used in conjunction with computer system 1000. The auxiliary I/O device interface can include general and customized interfaces that allow the processor 1002 to send and, more typically, receive data from other devices such as microphones, touch-sensitive displays, transducer card readers, tape readers, voice or handwriting recognizers, biometrics readers, cameras, portable mass storage devices, and other computers.

The computer system shown in FIG. 10 is but an example of a computer system suitable for use with the various embodiments disclosed herein. Other computer systems suitable for such use can include additional or fewer subsystems. In addition, bus 1014 is illustrative of any interconnection scheme serving to link the subsystems. Other computer architectures having different configurations of subsystems can also be utilized.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method, comprising:
acquiring, using a first thread, a to-be-handled user interface render event, wherein the first thread is a thread on a dynamic language application runtime platform, and wherein the dynamic language application runtime platform is preloaded with a render engine; and
calling, using the first thread, a corresponding user interface rendering function provided by the render engine based on an interface that corresponds to the event and that is used to call the render engine.

2. The method as described in claim 1, wherein:
the dynamic language application runtime platform is further preloaded with common modules; and
the method further comprises:
calling, using the first thread, a corresponding common function provided by a common module based on the interface that corresponds to the event and that is used to call the common module.

3. The method as described in claim 2, wherein the common modules comprise one or more of the following modules:
a network module configured to provide a network connection function; and/or
a system module configured to provide a system service function.

4. The method as described in claim 1, wherein:
the interface provided by the render engine comprises a first language interface;
the first language interface is mapped to a second language interface;
the first language interface is used to call the corresponding user interface rendering function provided in the render engine in the first language;
the second language is a dynamic language supported by the dynamic language application runtime platform;
the calling of the corresponding user interface rendering function provided by the render engine comprises:
acquiring, using the first thread, the second language interface that corresponds to the event and that is used to call the render engine;
accessing a mapping of the acquired second language interface to the corresponding first language interface; and
calling the corresponding user interface rendering function provided by the render engine based on the mapped first language interface.

5. The method as described in claim 4, wherein the calling of the corresponding user interface rendering function provided by the render engine comprises:
sending, using the first thread, a call instruction to a virtual machine, wherein the call instruction comprises a second language interface used to call the render engine, and wherein the call instruction triggers the virtual machine to map the second language interface to the corresponding first language interface; and
calling the corresponding user interface rendering function provided by the render engine based on the mapped first language interface.

6. The method as described in claim 1, wherein the acquiring of the to-be-handled user interface render event comprises:
acquiring the to-be-handled user interface render event from a dynamic language application runtime platform event queue upon receiving a callback function notification, wherein the callback function notifies the first thread in response to a determination that the user interface render event enters the event queue.

7. The method as described in claim 6, further comprising:
receiving, using a second thread, an operating system-related event from the operating system; and
storing the operating system-related event in the event queue, wherein the operating system-related event comprises a user interface render event.

8. The method as described in claim 1, further comprising:
in response to a determination that the dynamic language application runtime platform starts:
mapping a first language interface provided by the render engine to a second language interface; and
storing information on a mapping relationship between the first language interface provided by the render engine and the mapped second language interface; and
loading the interface-mapped render engine onto the dynamic language application runtime platform.

9. The method as described in claim 4, wherein:
the dynamic language application runtime platform comprises Node.js; and
the second language comprises JavaScript.

10. A system, comprising:
a processor; and
a memory coupled with the processor, wherein the memory is configured to provide the processor with instructions which when executed cause the processor to:
acquire, using a first thread, a to-be-handled user interface render event, wherein the first thread is a thread on a dynamic language application runtime platform, and wherein the dynamic language application runtime platform is preloaded with a render engine; and
call, using the first thread, a corresponding user interface rendering function provided by the render engine based on an interface that corresponds to the event and that is used to call the render engine.

11. The system as described in claim 10, wherein:
the dynamic language application runtime platform is further preloaded with common modules; and
the processor is further configured to:
call, using the first thread, a corresponding common function provided by a common module based on the interface that corresponds to the event and that is used to call the common module.

12. The system as described in claim 10, wherein:
the interface provided by the render engine comprises a first language interface;
the first language interface is mapped to a second language interface;
the first language interface is used to call the corresponding user interface rendering function provided in the render engine in the first language;
the second language is a dynamic language supported by the dynamic language application runtime platform;
the calling of the corresponding user interface rendering function provided by the render engine comprises to:
acquire, using the first thread, the second language interface that corresponds to the event and that is used to call the render engine;
access a mapping of the acquired second language interface to the corresponding first language interface; and
call the corresponding user interface rendering function provided by the render engine based on the mapped first language interface.

13. The system as described in claim 12, the calling of the corresponding user interface rendering function provided by the render engine comprises to:
send, using the first thread, a call instruction to a virtual machine, wherein the call instruction comprises a second language interface used to call the render engine, and wherein the call instruction triggers the virtual machine to map the second language interface to the corresponding first language interface; and
call the corresponding user interface rendering function provided by the render engine based on the mapped first language interface.

14. The system as described in claim 10, wherein the acquiring of the to-be-handled user interface render event comprises to:
acquire the to-be-handled user interface render event from a dynamic language application runtime platform event queue upon receiving a callback function notification, wherein the callback function notifies the first thread in response to a determination that the user interface render event enters the event queue.

15. The system as described in claim 12, wherein:
the dynamic language application runtime platform comprises Node.js; and
the second language comprises JavaScript.

16. A computer program product being embodied in a tangible non-transitory computer readable storage medium and comprising computer instructions for:
acquiring, using a first thread, a to-be-handled user interface render event, wherein the first thread is a thread on a dynamic language application runtime platform, and wherein the dynamic language application runtime platform is preloaded with a render engine; and
calling, using the first thread, a corresponding user interface rendering function provided by the render engine based on an interface that corresponds to the event and that is used to call the render engine.
